(19) United States
(12) Patent Application Publication
(10) Pub. No.: US 2016/0132814 A1
(43) Pub. Date: May 12, 2016

(54) CALCULATING CUSTOMER EXPERIENCE BASED ON PRODUCT PERFORMANCE

(71) Applicant: International Business Machines Corporation, Armonk, NY (US)

(72) Inventors: James D. Jamison, III, Aurora, CO (US); Charles C. Snow, Jefferson, MA (US)

(21) Appl. No.: 14/536,170

(22) Filed: Nov. 7, 2014

(51) Int. Cl. G06Q 10/06; G06Q 30/02

(52) U.S. Cl. CPC G06Q 10/06398; G06Q 30/0242

(57) ABSTRACT

A system, method and program product are provided for calculating a customer lifetime benefit (CLB) metric. A system is disclosed that includes: a communication system that provides a communication link to a plurality of CLB compatible products; an event processor that detects and processes events occurring on the plurality of CLB compatible products; a response engine that determines an appropriate action from a set of possible actions to take in response to event data detected on a CLB compatible product, wherein the set of possible actions includes triggering a corrective action on the CLB compatible product; and a lifecycle benefits analyzer that calculates a CLB metric based on operational compliance data of the CLB compatible product and resolution data resulting from corrective actions taken by the response engine.

### TECHNICAL FIELD

The subject matter of this invention relates to customer experience and, more specifically, to a system and method for calculating customer experience based on product performance.

### BACKGROUND

Customer experience as a technology area has traditionally been the domain of marketing, customer service and product manufacturing organizations responsible for creating and selling products and services. Typical approaches to understanding customer experience have focused on gathering data and information about the customer, including their behaviors, preferences and interactions with a company's employees, physical locations, on-line presence or business partners. Other approaches to customer experience have been to gather survey information on a customer's satisfaction with a product and its associated accessories.

Regardless of how the information and data is collected, companies typically feed this data into some type of analytic tool to gain insight and eventually take action. Some tools have evolved to the point where they can deliver a level of real time responses or actions based on detected events, historical data, profiles, preferences, product enhancement timelines, product fix requirements, safety compliance or security compliance concerns. Traditionally, the primary motive for these companies has not really centered on the customer's experience, but rather on the customer's potential impact to a company's customer lifetime value metrics (CLV) or market share attainment metrics. In some cases, product manufacturers use the data to make modifications to their products. In other instances, the data is collected to apply automated updates and fixes to products, as in the case with mobile devices and computers. Unfortunately, the collection of such data is rarely used to immediately impact and improve customer experience.

### SUMMARY

The present invention provides a system and method that allows companies to measure product performance in real time, including implementing and assessing automated remote actions with the product's components (hardware and/or software) to impact customer experience. In one embodiment, these remote actions adapt the product components in a manner that determines which actions will have an optimized impact on the customer's experience. This approach provides a direct link between product performance, corrective action and measurable customer benefit, providing greater accuracy in determining customer experience.

A first aspect of the invention provides a customer lifetime benefit (CLB) system, comprising: a communication system that provides a communication link to a plurality of CLB compatible products; an event processor that detects and processes events occurring on the plurality of CLB compatible products; a response engine that determines an appropriate action from a set of possible actions to take in response to event data detected on a CLB compatible product, wherein the set of possible actions includes triggering a corrective action on the CLB compatible product; and a lifecycle benefits analyzer that calculates a CLB metric based on operational compliance data of the CLB compatible product and resolution data resulting from corrective actions taken by the response engine.

A second aspect of the invention provides a computerized method for calculating a customer lifetime benefit (CLB) metric for customers of CLB compatible products, comprising: providing a communication link to a plurality of CLB compatible products; detecting and processing events occurring on the plurality of CLB compatible products; determining an appropriate action from a set of possible actions to take in response to event data detected on a CLB compatible product, wherein the set of possible actions includes triggering a corrective action on the CLB compatible product; and calculating a CLB metric based on operational compliance data of the CLB compatible product and resolution data resulting from corrective actions taken by the response engine.

A third aspect of the invention provides a program product stored on a computer readable storage medium, which when executed by a computer system, calculates a customer lifetime benefit (CLB) metric for customers of CLB compatible products, comprising: program code for providing a communication link to a plurality of CLB compatible products; program code for detecting and processing events occurring on the plurality of CLB compatible products; program code for determining an appropriate action from a set of possible actions to take in response to event data detected on a CLB compatible product, wherein the set of possible actions includes triggering a corrective action on the CLB compatible product; and program code for calculating a CLB metric based on operational compliance data of the CLB compatible product and resolution data resulting from corrective actions taken by the response engine.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a CLB system according to embodiments of the invention.

FIG. 2 shows a flow diagram of a configuration phase according to embodiments of the invention.

FIG. 3 shows a flow diagram for processing a system event according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The embodiments described herein disclose a customer lifetime benefit (CLB) solution for evaluating customer experience based on real time product performance data. A CLB metric is calculated based on two primary attributes defined as Product Benefit and Resolution Quality. Product Benefit determines customer experience based upon the compliance of a product's components to meet officially published functional and non-functional specifications and design parameters, i.e., product benefit measures what a customer is actually experiencing in using a product as compared to generally available official performance or operational documentation. Resolution Quality refers to how well automated corrective actions positively influence customer experience. Additionally, the use of product related promotions to influence customer experience may be measured and incorporated into the CLB metric.

A CLB system is described that is comprised of subsystems that process product events, calculate customer lifetime benefit metrics, determine and evaluate corrective action resolution, establish CLB system policies, store product and component details, and enable internal CLB communications and external communications between the CLB and the products of interest or product associated systems.

The Customer Lifetime Benefit (CLB) system may, for example, be utilized in fields of Smarter Commerce, customer experience management, operational decision management, context aware wireless sensor networks, ubiquitous computing, ambient intelligence, machine-to-machine, Internet-of-Things and other, similar fields. The CLB system uses data gathered from the components of a CLB compatible product to determine events and conditions that indicate operational performance compliance or non-compliance as compared to, e.g., officially published product functional and non-functional design parameters. In one embodiment, a compatible CLB product is any physical object that is produced by a company or manufacturer that includes at least one component that is comprised of some combination of electrical, mechanical, electro-mechanical and/or software parts (e.g., packaged product, device, or equivalent system) that can be accessed, controlled and/or monitored by the CLB system. The product and component product data is used to determine what, if any, remote action can be taken to bring the product and component into acceptable operational compliance. A CLB metric is determined based on a type of component event, compliancy issue resolution and the impact of the promotions acceptance rate. In one embodiment, a promotion is defined to be any offer, discount, incentive or similar activity that is made available to buyers of the product to address potential customer satisfaction issues or inconveniences because of product performance non-compliance.

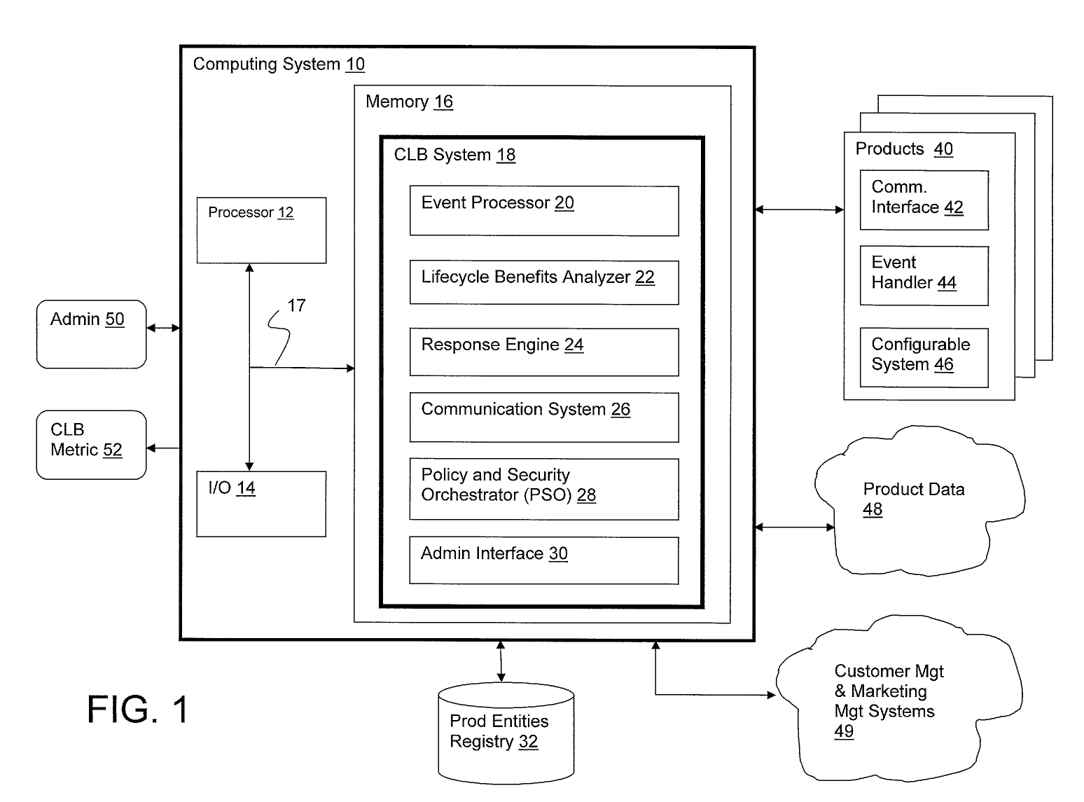

FIG. 1 depicts a computing system 10 having a CLB system 18 stored in memory 16, which when executed by processor 12, implements the features described herein. As shown in FIG. 1, CLB system 18 interfaces with various CLB compatible products (“products”) 40 being utilized by customers, e.g., via some type of network such as the Web. CLB system 18 generally includes an event processor 20, a lifecycle benefits analyzer 22, a response engine 24, a communication system 26, a policy and security orchestrator 28 and an administrator interface 30. Each CLB compatible product 40 generally includes a communication interface 42 for communicating with CLB system 18, and event handler 44 for managing events occurring on the product 40 and at least one configurable system 46 that can be remotely controlled by the CLB system 18.

Within the CLB system 18, the event processor 20 provides the mechanism for tracking and analyzing streams of information about conditions of interest associated with products 40. These events are sent by a product's event handler 44, providing information on the operational state of a product 40, responses to CLB system actions and data related to the environmental conditions in which a product 40 is being used.

The lifecycle benefits analyzer 22 executes algorithms to calculate the customer lifetime benefit (CLB) metric. The lifecycle benefits analyzer 22 uses a combination of parameters to calculate a customer lifetime benefit metric that defines whether the product 40 is operating in accordance with acceptable, generally available, official documentation, warranties and specifications, i.e., as provided by product data 48.

The response engine 24 applies rules and algorithms to determine the appropriate action that should be taken to respond to event data received from the product. The algorithms may, for example, determine if an automated corrective action is possible that would allow CLB system 18 to resolve a problem.

Communication system 26 brokers communication with products 40 and with other system components and with external devices, such as product data 48 and customer management and marketing management systems 49.

The policy and security orchestrator (PSO) 28 maintains and enforces policies to grant or deny applications and individuals access to products 40, product data 48 and to other CLB system 18 components. These policies, for example, impose access control on the retrieval of product data and enforce limits on the functions users and applications are authorized to perform when interacting with the data. The PSO 28 also maintains the policies and rules that are used by the response engine 24 and lifecycle benefits analyzer 22.

Administrator interface 30 serves as the presentation layer for human-computer interaction to enable the configuration of CLB system components by an administrator 50.

The product entities registry 32 stores and maintains associations of relevant product data, component data, apparatus data, and relationships between products and customers. Examples of this data are provided in Table 1. This would also include information on types of triggers, messages or data that are valid for a product. Additional external systems include those systems that would provide additional product information, component information, promotion information, policy, security and rules information and other data that could be entered as part of the configuration phase (described below).

TABLE 1
Example product or component level data

| | |
|---|---|
| Manufacturer name | Functional specification |
| | parameters and thresholds |
| Product name | Non-functional specification |
| | parameters of interest |
| Product model, type and version | Criticality of component to |
| | operational performance |
| Unique product identification | Environment operating conditions |
| Warranty period | Sensor enabled components of interest |
| Valid promotion types | Actuator components of interest |

For example, consider the case of a consumer product 40 such as a high-end espresso/cappuccino unit that is a CLB system compatible product. The unit would include sensors that, for example, measure water temperature, time to brew, and other operational characteristics and parameters. The sensors would collect such information and report events back to the event processor 20 via an event handler 44. In the case where the unit was not functioning according to published specifications, (e.g., temperature too high or low), a response engine 24 could remotely recalibrate the unit to operate in the proper range. To offset the inconvenience and maintain loyalty, the owner may receive, (e.g., via email), a trackable coupon for free coffee. As a separate process, the lifecycle benefits analyzer 22 would periodically or on-demand calculate/update a CLB metric 52 that would take into account how well the unit is operating, what type of corrective actions were taken and their success, and the effectiveness of any promotions (e.g., whether the promotion was used by the owner).

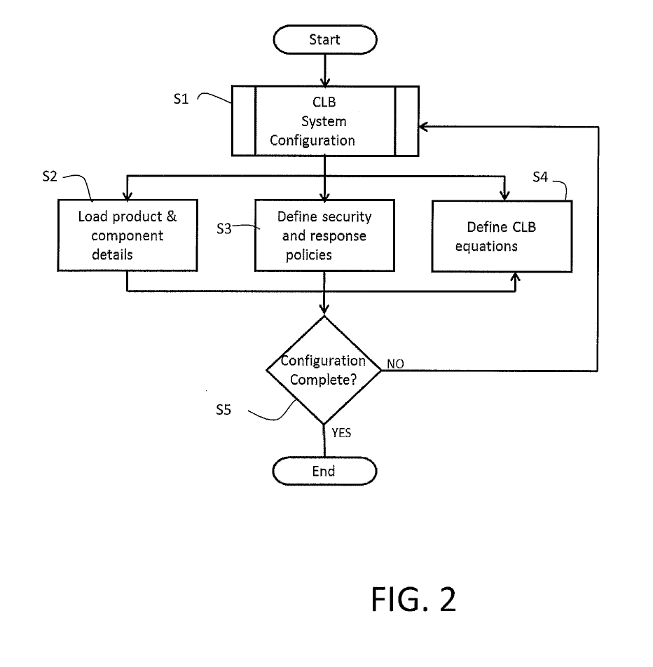

FIG. 2 depicts a flow diagram showing a system configuration phase of a CLB process (with reference to FIG. 1). The CLB system configuration phase S1 is the phase in which the CLB system 18 establishes compatible products and associated components of interest for which a CLB metric 52 will be calculated. In this illustrative embodiment, product and component details are loaded at S2, security and response policies are loaded at S3, and CLB equations are defined at S4. At S5, a determination is made whether the configuration is complete.

Load Product and Component Details (S2)—

this phase is completed by loading product and component data into the product entities registry 32 either through the use of the administrator interface 30 by an authorized user, through the communication system 26 by connection to a product information management system used as part of a product lifecycle management architecture, or through products that have the capability to provide detailed information directly to the CLB system 28. Examples of product and component data are provided in Table 1 above.

Define Security and Response Policies (S3)—

this phase is completed by establishing the policies that will be used to authenticate and authorize administrative users 50, external products and external systems to communicate with the CLB system 18. Authorized administrative users 50 are people or systems that have the capability of configuring the CLB system 18 or providing data to the CLB system 18. In addition, policies are established relative to plausibility of remote corrective action, corrective action response resolution times, market differentiated components or features, promotion types, and frequency thresholds for receiving input from products or polling to collect information from products. This is accomplished through the administrator interface 30 and the PSO 28. An additional option is to integrate the PSO 28 with external systems whose primary functions are to establish policies, rules, constraints or standards through the communication system 26.

Define CLB Metric Equations (S4)—

this phase is completed when authorized administrative users 50 have defined the equations that will be used by the lifecycle benefits analyzer 22. Equations can be defined as linear or non-linear relationships. In general, these equations are entered through administrator interface 30 or through a system with the capability to define equations that can be integrated into lifecycle benefits analyzer 22 using well known data integration or service oriented integration techniques.

In one illustrative embodiment, a representative linear equation may be provided as follows:

CLB(Cᵢ)=PB(Cᵢ)×RQ(Cᵢ) I.
a. CLB—the customer lifetime benefit metric for a component (Cᵢ) of a product for which (i) uniquely identifies the component of interest or a specific product of interest. The product must include some mechanism through which the product's identify can be verified and validated by the PSO 28 using apparatus within the product's form factor similar in purpose and function to an object identifier, addressing schema or naming convention (e.g., electronic product code, network address, domain name service). In some cases, the use of the identifier can be extended to individual components within the product to verify and validate compliance to product engineering specifications.

Where PB(Cᵢ)=Σ([Tₚ₁×(DF₁+DF₂+ . . . +DFₐ)]+[Tₚ₂×(DF₁+DF₂+ . . . +DFₐ)]+ . . . +[Tₚₓ×(DF₁+DF₂+ . . . +DFₐ)]) II.
a. PB(Cᵢ)—defines the product benefit (PB) as a function of design factors or specifications that can be measured to determine a product's operational performance for Cᵢ.
b. DFₐ—establishes each unique design factor (DF) for which (1≦a<∞) is the number of design factors for a component or product. Representative examples would include functional specifications, non-functional specifications, environment operating conditions, warranty compliance periods and expected operational lifetime. The PB calculation includes those design factors whose operational compliance can be measured by an apparatus similar in purpose to a sensor.
c. Tₚₓ—establishes the set of weighted threshold attributes (T) used to distinguish the design factors' impact on the PB calculation, where the values of Tₚₓ are 1≦px<∞ where px is the unique identifier for a specific attribute.

Where RQ(Cᵢ)=Σ([T_{q1}×(CA₁+CA₂+ . . . +CAₐ)]+[T_{q2}×(CA₁+CA₂+ . . . +CAₐ)]+ . . . +[T_{qx}×(CA₁+CA₂+ . . . +CA_{b})] III.
a. RQ(Cᵢ)—defines the resolution quality (RQ) as a function of corrective action resolution results that can be detected by the CLB system or supplied to the CLB system for Cᵢ.
b. CAₐ—establishes the set of unique corrective action (CA) resolution results for which (1≦a<∞) is the number of resolution results of interest to calculating PB(Cᵢ). These are either actions that are taken by the CLB system or actions taken relative to the product to incent a positive interaction with the customer, such as a product promotion. Representative examples would include whether the issue was resolved, time to resolve the problem, and impact of any promotions used. The PB calculation for CLB action includes those resolution results whose operational compliance can be accomplished with an apparatus similar in purpose to an actuator and confirmed by an apparatus similar in purpose to a sensor. If the use of promotions or similar result is a desired CAₐ, this data can be imported or extracted from external systems to the CLB system through the communication system 26.
c. T_{qy}—establishes the set of weighted threshold attributes used to distinguish the corrective action resolution factors' impact on the PB calculation, where the values of T_{qy} are 1≦qy<∞ and qy is the unique identifier for a specific attribute.

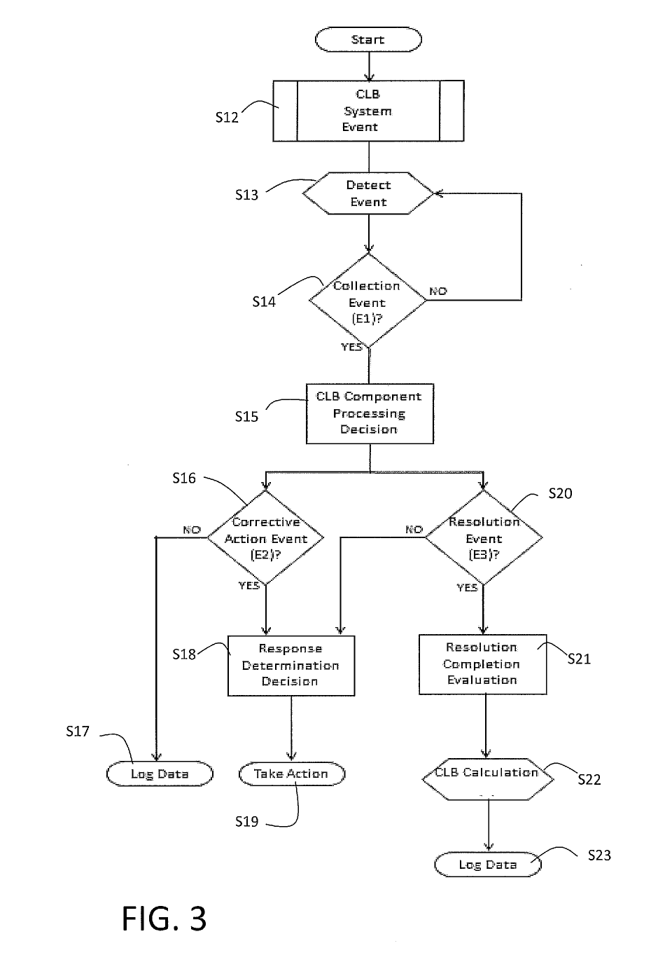

FIG. 3 depicts a flow diagram showing an illustrative method for implementing the CLB system event phase, in which information about a product's performance is collected, a determination is made of the plausibility of taking remote corrective action and, if plausible and consistent with defined policies, that action is taken and evaluated for results. In this example, a CLB system event occurs at S12 and at S13 an event is detected. At S14, a determination is made whether the event is a collection event (E1) and if not, logic loops back to S13. If it is established to be a collection event (E1), a CLB component processing decision is made at S15 in which the event is checked to see if it is a corrective action event (E2) at S16 or whether it is a resolution event (E3) at S20.

If the event is not a corrective action event (i.e., the event contains normal operational data), then the data is logged at S17. If the event is a corrective action event (i.e., one that requires some corrective action), then a response determination decision is made at S18 and the appropriate action is taken at S19. Similarly, if the event is not a resolution event (E3) at S20, then a response determination decision is made at S18 and the appropriate action is taken at S19. If the event is a resolution event, then a resolution completion evaluation occurs at 21 (i.e., did the action correct the issue?), followed by a CLB calculation at S22 and a logging of the data at S23.

A collection event (E1) generally refers to product performance data collection. A corrective action event (E2) generally refers to a situation where a remote corrective action on a product or component is required, possible and taken. A resolution event (E3) refers generally to a detection of results of a corrective action event.

With regard to collection events, The CLB system 18 provides two ways of collecting data: reactively and proactively. In the case of reactive data collection, the CLB system is responding to event triggers of interest sent by the product to the event processor 20. The reactive event triggers of interest are defined within the PSO 28, which also performs validation and authentication on the source of the triggers. Reactive event triggers provide overall status information on the product and the components. Representative triggers would include operational performance compliance, operational performance non-compliance, product component configuration changes, product operating environment information and product location information. In the case of proactive data collection, the PSO 28 establishes timing-based polling triggers for when the CLB system 18 detects either the operational condition of the product or the results of corrective actions taken by the response engine 24. In both cases it is the event processor 20 that processes triggers and determines where data is sent within the CLB system 18.

With regard to corrective action events, the response engine 24 integrates with the product entities registry 32 and PSO 28 to determine if remote corrective actions are possible for parts within the product. The response engine 24 and the PSO 28 determine the types of actions, the number of times actions can be executed and the acceptable resolution waiting periods for corrective actions. The types of actions that can be taken for a specific product and associated components are based upon what has been designed, embedded or added into the product. In the case of product parts that have controllable apparatuses equivalent to an actuator, the product entities registry 32 maintains the valid messaging or signals that can be sent for corrective action, including formats and commands which are then executed by the response engine 24 through the communication system 26. In the case of software products that require code-related corrective actions which can be requested, the product entities registry maintains the types of triggers, messages or data that can be sent by the response engine 24 through the communications system 26 to the product 40, forcing a request to be sent to the appropriate external systems for the required software or code.

With regard to corrective action results (E3), the response engine maintains a log of which corrective actions have been taken and integrates with PSO 28 to evaluate policy and resolution compliance. Once policy constraints are met, final results of the corrective actions are published to the lifetime benefits analyzer 22.

As shown in FIG. 3, the CLB calculation at S22 is one possible phase in which the CLB metric 52 may be computed. The CLB metric 52 calculation may be done based on one of two conditions: event or policy. In the case of an event, the CLB metric 52 is calculated corresponding to triggers that have been executed and responded to by the response engine. In the case of policies, the CLB metric 52 is calculated based on established time periods. In both cases, the lifetime benefits analyzer 22 maintains a log of data that can be used to modify equations that enhance the ability to accurately measure customer benefit.

It is understood that the CLB system 18 can be implemented as a single, self-contained apparatus, a distributed set of on-premise subsystems, as a cloud-based system or a hybrid of on-premise and cloud. In one embodiment, the CLB system 18 is a cloud-based system for which stakeholders of interest subscribe to a CLB metric 52 calculation service.

Furthermore, the present invention may be implemented as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable, programmable, read-only memory (EPROM or Flash memory), a static random access memory (SRAM), a portable compact disc read-only memory (CD-ROM), a digital versatile disc (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, such as the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely or partly on a computer, device and/or apparatus, as a stand-alone software package, partly on a computer and partly on a remote computer or entirely on the remote computer or server. In the latter scenario, the remote computer may be connected to the user's computer through any type of network, including a local area network (LAN), a wide area network (WAN), geo-fence, Broadband wireless, near field wireless, personal area network, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts an illustrative computing system 10 that may comprise any type of computing device and, for example, includes at least one processor, memory, an input/output (I/O) 14 (e.g., one or more I/O interfaces and/or devices), and a communications pathway 17. In general, processor(s) 12 execute program code, such as CLB system 18, which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10. To this extent, CLB system 18 can manage a set of interfaces (e.g., graphical user interfaces, application program interfaces, etc.) that enable humans and/or other systems to interact with the CLB system 18. Further, CLB system 18 can manage (e.g., store, retrieve, create, manipulate, organize, present, etc.) data using any solution.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A customer lifetime benefit (CLB) system, comprising:
a communication system that provides a communication link to a plurality of CLB compatible products;
an event processor that detects and processes events occurring on the plurality of CLB compatible products;
a response engine that determines an appropriate action from a set of possible actions to take in response to event data detected on a CLB compatible product, wherein the set of possible actions includes triggering a corrective action on the CLB compatible product; and
a lifecycle benefits analyzer that calculates a CLB metric based on operational compliance data of the CLB compatible product and resolution data resulting from corrective actions taken by the response engine.

2. The CLB system of claim 1, wherein the CLB metric is further based on promotional impact data that measures the effectiveness of a promotion sent to a customer.

3. The CLB system of claim 1, wherein the operational compliance data is calculated based on a comparison of collected event data against product design specifications.

4. The CLB system of claim 1, wherein the resolution data is calculated based on a success or failure of a corrective action.

5. The CLB system of claim 1, further comprising a policy and security orchestrator for controlling access to CLB compatible products.

6. The CLB system of claim 1, further comprising a product entities registry for storing CLB compatible product specifications and promotions, and associated CLB equations.

7. The CLB system of claim 1, wherein the CLB metric is calculated periodically or in response to a triggering event.

8. A computerized method for calculating a customer lifetime benefit (CLB) metric for customers of CLB compatible products, comprising:
providing a communication link to a plurality of CLB compatible products;
detecting and processing events occurring on the plurality of CLB compatible products;
determining an appropriate action from a set of possible actions to take in response to event data detected on a CLB compatible product, wherein the set of possible actions includes triggering a corrective action on the CLB compatible product; and
calculating a CLB metric based on operational compliance data of the CLB compatible product and resolution data resulting from corrective actions taken by the response engine.

9. The computerized method of claim 8, wherein the CLB metric is further based on promotional impact data that measures an effectiveness of a promotion sent to a customer.

10. The computerized method of claim 8, wherein the operational compliance data is calculated based on a comparison of collected event data against product design specifications.

11. The computerized method of claim 8, wherein the resolution data is calculated based on a success or failure of a corrective action.

12. The computerized method of claim 8, further comprising controlling access to CLB compatible products.

13. The computerized method of claim 8, further comprising storing CLB compatible product specifications and promotions, and associated CLB equations.

14. The computerized method of claim 8, wherein the CLB metric is calculated periodically or in response to a triggering event.

15. A program product stored on a computer readable storage medium, which when executed by a computer system, calculates a customer lifetime benefit (CLB) metric for customers of CLB compatible products, comprising:
program code for providing a communication link to a plurality of CLB compatible products;
program code for detecting and processing events occurring on the plurality of CLB compatible products;
program code for determining an appropriate action from a set possible actions to take in response to event data detected on a CLB compatible product, wherein the set of possible actions includes triggering a corrective action on the CLB compatible product; and
program code for calculating a CLB metric based on operational compliance data of the CLB compatible product and resolution data resulting from corrective actions taken by the response engine.

16. The program product of claim 15, wherein the CLB metric is further based on promotional impact data that measures the effectiveness of a promotion sent to a customer.

17. The program product of claim 15, wherein the operational compliance data is calculated based on a comparison of collected event data against product design specifications.

18. The program product of claim 15, wherein the resolution data is calculated based on a success or failure of a corrective action.

19. The program product of claim 15, further comprising program code for controlling access to CLB compatible products.

20. The program product of claim 15, further comprising program code for storing CLB compatible product specifications and promotions, and associated CLB equations.
